(19) United States
(12) Patent Application Publication
(10) Pub. No.: US 2011/0164193 A1
(43) Pub. Date: Jul. 7, 2011

(54) CHILDREN'S STORY AUDIO/VIDEO PLAYER

(76) Inventor: Kuang-Tsai Hao, Taipei (TW)

(21) Appl. No.: 12/651,698

(22) Filed: Jan. 4, 2010

(51) Int. Cl. H04N 5/64; H04N 5/91

(52) U.S. Cl. 348/838; 348/E05.128

(57) ABSTRACT

A children's story audio/video player includes a player body having a housing, a liquid crystal display installed at a front side of the housing, and at least one speaker installed at a selected position, characterized in that the housing comprises at least one roller control device installed at a front side of the housing for controlling the liquid crystal display to switch a playing menu and at least one press key control device for controlling the liquid crystal display to switch a page, such that the children's story audio/video player can use the roller control device and the press key control device o achieve the effect of a quick, simple, easy and convenient operation.

### FIELD OF THE INVENTION

The present invention relates to a children's story audio/video player, in particular to a structural design of a children's story audio/video player having simple and easy hardware control devices installed at a front side of the player.

### BACKGROUND OF THE INVENTION

Traditional children story books display contents simply in words and pictures, and thus children can obtain different impressions from single words and fixed pictures, but cannot listen or learn the pronunciation of the words or other languages while reading a story or watch the display of animations. As a result, the learning effect achieved by reading the story books is very limited, and children may lose the fun of learning easily. Furthermore, traditional children story books are in the form of physical books whose large quantity of words and pictures are divided into volumes and published in series, so that the heavy book series not only occupies children's living space, but also creates a large learning pressure intangibly. Obviously, the traditional children story books are unable to use technologies to provide a diversified learning method to children. As to modern points of view, the traditional children story books actually constitute an obstacle to children's learning. However, present technological products such as desktop and notebook computers capable of playing texts, animations, voices, sounds and music of a children's story usually come with hardware devices with a too-complicated operation and cannot achieve the quick, simple, easy and convenient operation effect. Therefore, it is a main subject for the present invention to develop a children's story audio/video player having hardware control devices for directly controlling contents displayed by a liquid crystal display, so as to achieve the effect of the quick, simple, easy and convenient operation.

### SUMMARY OF THE INVENTION

In view of the aforementioned shortcomings of the prior art, the inventor of the present invention based on years of experience in the related industry to conduct extensive researches and experiments, and finally developed a children's story audio/video player in accordance with the present invention to achieve a quick, simple, easy and convenient operation.

Therefore, it is a primary objective of the present invention to provide a children's story audio/video player with a design having hardware control devices such as at least one roller control device and at least one press key control device installed at a front side of a player body for directly controlling contents displayed by a liquid crystal display, so as to achieve the effect of a quick, simple, easy and convenient operation.

Another objective of the present invention is to provide a children's story audio/video player with a structural design of a player body for giving a convenient grip to hold the player.

To achieve the foregoing objectives, the present invention provides a children's story audio/video player comprising: a player body, having a housing, a liquid crystal display installed at a front side of the housing, and at least one speaker installed at a selected position, characterized in that at least one roller control device installed at the front side of the housing for controlling the liquid crystal display to switch a playing menu, and a press key control device for controlling the liquid crystal display to switch a page.

Therefore, the children's story audio/video player of the present invention provides children a way of pushing and moving the roller control device to control the liquid crystal display to switch a playing menu and start playing a story, and also provides children a way of pressing the press key control device to control the liquid crystal display to switch a page, so as to achieve the effect of a quick, simple, easy and convenient operation.

### BRIEF DESCRIPTION OF THE DRAWINGS

FIG. 1 is a perspective view of a preferred embodiment of the present invention;

FIG. 2 is a front view of a preferred embodiment of the present invention;

FIG. 3 is a side view of a preferred embodiment of the present invention;

FIG. 4 is a rear view of a preferred embodiment of the present invention;

FIG. 5 is a bottom view of a preferred embodiment of the present invention; and

FIG. 6 is a schematic view of a software operating interface in accordance with a preferred embodiment of the present invention.

### DESCRIPTION OF THE PREFERRED EMBODIMENTS

To make it easier for the examiner to understand the objects, characteristics and effects of this invention, we use a preferred embodiment together with the attached drawings for the detailed description of the invention.

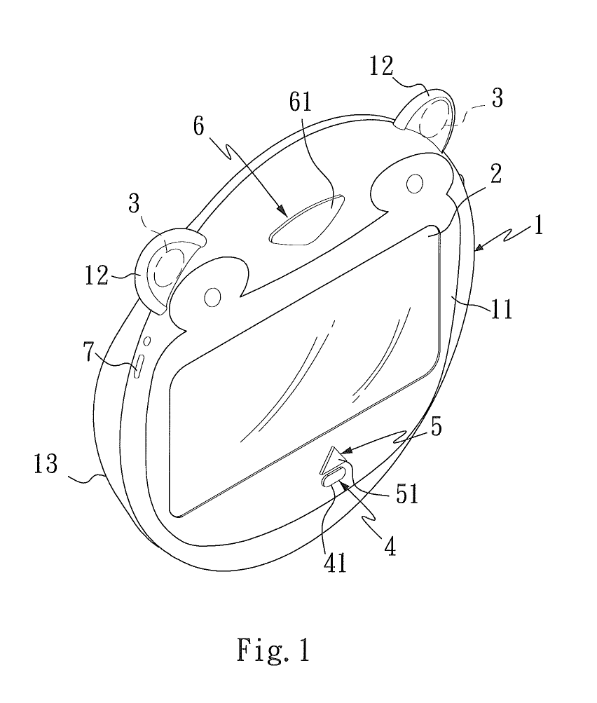

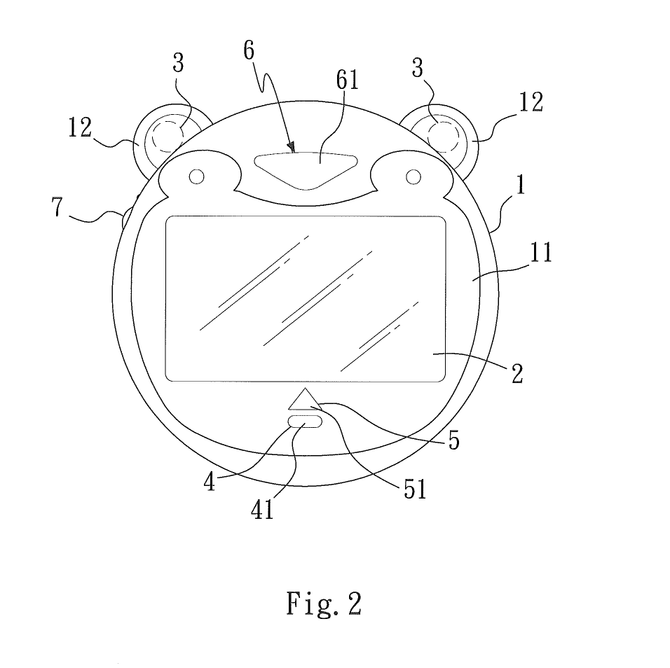

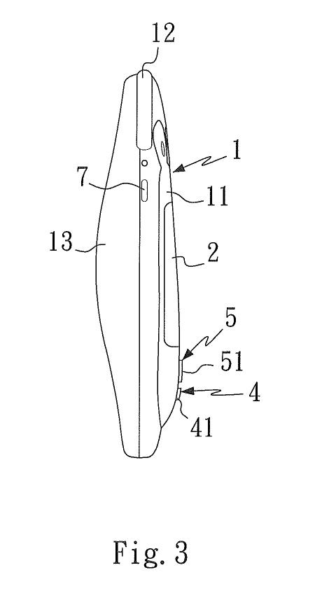

With reference to FIGS. 1 to 3 for a children's story audio/video player in accordance with a preferred embodiment of the present invention, the children's story audio/video player comprises: a player body 1, having a housing 11, a liquid crystal display 2 (which is a TFT-LCD) installed at a front side of the housing 11, and at least one speaker 3 installed at a selected position, wherein the housing 11 contains hardware devices such as a controller for driving the liquid crystal display 2 to produce images and the speaker 3 to produce sounds, a storage device and a power supply, etc, such that the children's story audio/video player can produce the effect of texts, animation images and sounds. The present invention is characterized in that the housing 11 includes at least one roller control device 4 installed at a front side of the housing 11 for controlling the liquid crystal display 2 to switch a playing menu and a press key control device 5 for controlling the liquid crystal display 2 to switch a page. The roller control device 4 is a hardware device including a roller 41 and an optical module. If a user pushes and moves the roller 41, the optical module will detect rotations of the roller 41 to generate and transmit a signal to the controller, and the press key control device 5 includes a press key 51 and a hardware device circuit contact, and the aforementioned components constitute the children's story audio/video player of the present invention.

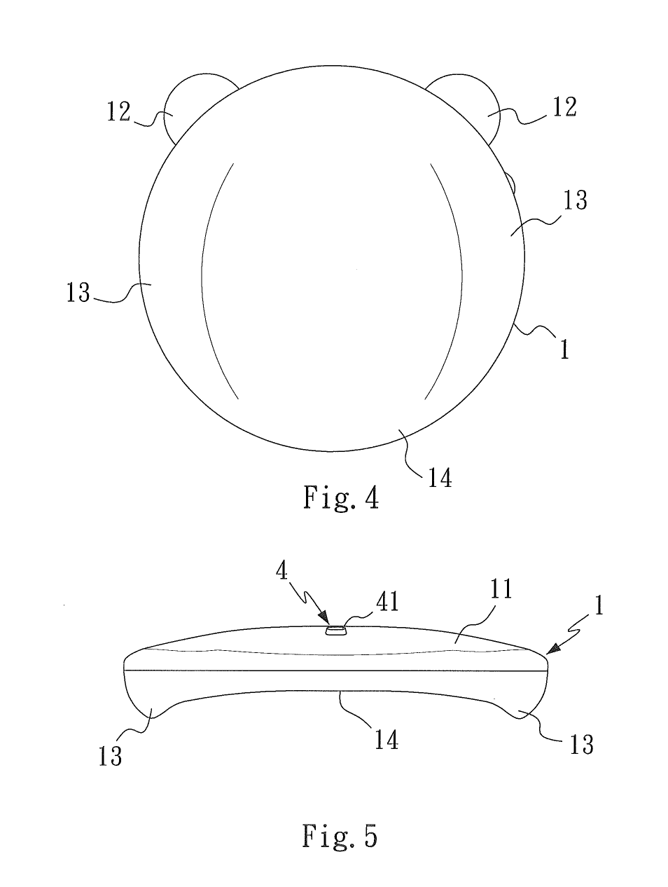

In FIGS. 1 to 3, the children's story audio/video player in accordance with a preferred embodiment of the present invention further comprises a power control device 6 installed at a front side of the housing 11 or any other selected position. The power control device 6 can be a hardware device including a press key 61 and a circuit contact, such that when a user presses the press key 61 of the power control device 6, the children's story audio/video player will be powered on or off. The housing 11 further includes a sound volume control device 7 installed on a lateral side or at any other selected position, wherein the sound volume control device 7 is provided for adjusting the sound volume of the speaker 3. In addition, the housing 11 further includes two lug portions 12 disposed on both lateral sides or other selected positions respectively, such that if the speaker 3 is installed in the lug portion 12, the lug portion 12 of the player body 1 can be designed with a shape of an animal face, while providing the function of producing sounds. In FIGS. 4 and 5, the housing 11 includes a holding protrusion 13 disposed on a backside of the housing 11 and at a position proximate to each of both sides of the housing 11, such that children can hold the children's story audio/video player easily, and a recession 14 is defined between the two holding protrusions 13, so that children can hold the holding protrusion 13 by a hand or both hands, while reading and listening to a story.

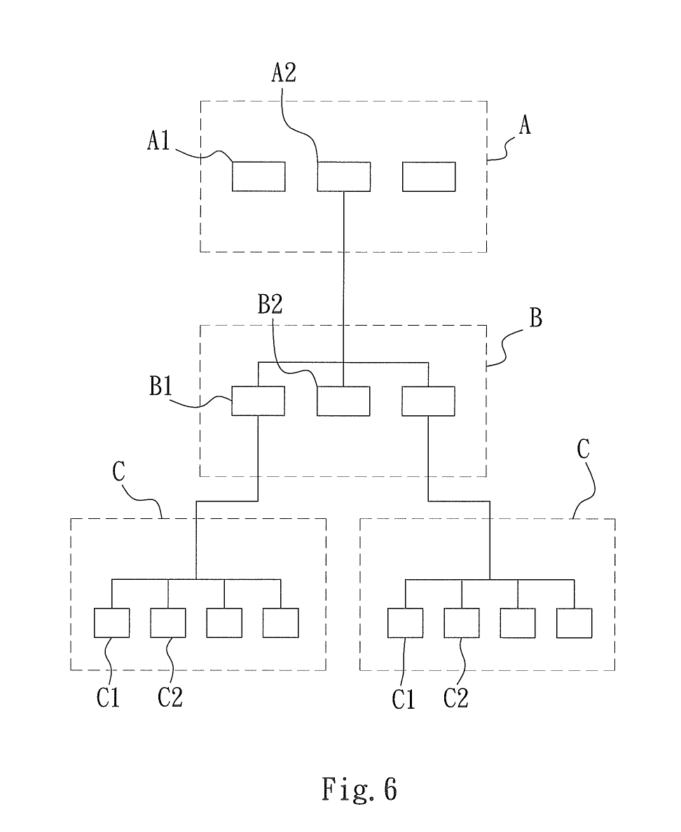

If it is necessary to operate and use the children's story audio/video player of the present invention, a user just needs to press the press key 61 of the power control device 6 to power on the children story audio/video player. In FIG. 6, the liquid crystal display 2 displays a primary page A, whose contents can be a plurality of primary playing menus A1, A2 . . . preinstalled through a software program, and the primary playing menus A1, A2 . . . of the primary page A can be classified into fables, Chinese stories, classic stories, religious stories, or other stories. The user can enter into a secondary page B of each primary playing menu, wherein the secondary page B also includes a plurality of secondary playing menus B1, B2 . . . preinstalled through the software program, wherein the secondary playing menus B1, B2 . . . of the secondary page B can be a title, an author, a chapter, or a section of a story. After entering into a tertiary page C under the secondary playing menu, the user can see a plurality of tertiary playing menus C1, C2 of the tertiary page C and its tertiary playing menus C1, C2 . . . , and an option of playing voices in Chinese, a foreign language, or a voice recorded by a user is set for the user's choice.

In the aforementioned software operating interface, a child user simply needs to push and move the roller 41 of the roller control device 4 to switch a primary playing menu A1, A2 . . . and a secondary playing menu B1, B2 . . . , C1, C2 . . . and achieve the effect of changing the playing menu. If the child user wants to click and select the playing menu A1, A2 . . . , B1, B2 . . . , C1, C2 . . . , the child user simply pushes the roller 41 of the roller control device 4 to enter a selected secondary or tertiary page or start playing the electronic audio/video story. If the child user wants to return to a previous page A or B, then the child user simply needs to press the press key 51 of the press key control device 5 to return to the previous page A or B. With the design of the roller control device 4 and the press key control device 5 of the children's story audio/video player in accordance with the present invention, the hardware interface for the operation will be much simpler and easier, and such quick, simple, easy, and convenient operation is particularly suitable for children to read and listen to children's stories.

In summation of the description above, the present invention comes with a design having hardware control devices such as at least one roller control device and at least one press key control device installed at a front side of the player body of the children's story audio/video player for directly controlling contents displayed by the liquid crystal display, so as to achieve the effect of a quick, simple, easy and convenient operation. In addition, products derived by the method of the invention can meet the market requirements, and the present invention complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A children's story audio/video player, comprising a player body, and the player body having a housing, and a liquid crystal display installed at a front side of the housing, characterized in that the housing comprises at least one roller control device installed at a front side of the housing for controlling the liquid crystal display to switch a playing menu and at least one press key control device for controlling the liquid crystal display to switch a page.

2. The children's story audio/video player of claim 1, wherein the housing includes a power control device installed at a selected position of the housing.

3. The children's story audio/video player of claim 1, wherein the housing includes a sound volume control device installed at a selected position of the housing.

4. The children's story audio/video player of claim 1, wherein the housing includes two lug portions disposed at a selected position of the housing, and the speaker is installed in the lug portion.

5. The children's story audio/video player of claim 1, wherein the housing includes a holding protrusion disposed on a backside of the housing and at a position proximate to each of both sides of the housing.
